(19) United States
(12) Patent Application Publication
(10) Pub. No.: US 2023/0024726 A1
(43) Pub. Date: Jan. 26, 2023

(54) COMMUNICATION METHOD FOR ELECTRONIC CIRCUITS OF AN ELECTRICAL ACCUMULATOR BATTERY

(71) Applicant: Commissariat à I'Énergie Atomique et aux Énergies Alternatives, Paris (FR)

(72) Inventors: Eric Fernandez, Grenoble Cedex 9 (FR); Sylvain Bacquet, Grenoble Cedex 9 (FR); Ghislain Despesse, Grenoble Cedex 9 (FR); Yan Lopez, Grenoble Cedex 9 (FR); Remy Thomas, Grenoble Cedex 9 (FR)

(73) Assignee: Commissariat à I'Énergie Atomique et aux Énergies Alternatives, Paris (FR)

(21) Appl. No.: 17/786,432

(22) PCT Filed: Dec. 16, 2020
(86) PCT No.: PCT/EP2020/086346

§ 371 Date: Jun. 16, 2022

(30) Foreign Application Priority Data
Dec. 20, 2019 (FR) FR1915090

(51) Int. Cl. H01M 10/42; G06F 13/42

(52) U.S. Cl. CPC H01M 10/425; G06F 13/4282; H01M 2010/4271; H01M 2010/4278

(57) ABSTRACT

A method of communication between a first electronic circuit and second electronic circuits via a bidirectional bus allowing the full duplex communication. Each second electronic circuit has a single identifier corresponding thereto. The method includes the transmission by the first electronic circuit of first frames over the bus to the second electronic circuits, the bits of each first frame being distributed in successive groups of bits, a first group of bits corresponding to a first identifier among the identifiers, a second group of bits corresponding to orders to be executed by the second electronic circuit corresponding to the first identifier, and a third group of bits corresponding to a second identifier among the identifiers, only the second electronic circuit corresponding to the second identifier being authorized to transmit a second frame to the first electronic circuit over the bus.

The present patent application claims the priority benefit of French patent application FR19/15090 which is herein incorporated by reference.

### TECHNICAL BACKGROUND

The present disclosure generally relates to a method of data exchange between electronic circuits, particularly electronic circuits of a battery of electrical accumulators, also called battery pack.

### PRIOR ART

It is known to form a battery comprising a plurality of stages or modules in each of which accumulators, also called cells, may be connected in series or in parallel by controllable switches. Such a battery is capable of delivering a voltage having its waveform varying over time by varying the cell connection over time via the turning on or the turning off of the switches.

The battery may comprise a control circuit, called master control circuit, capable of transmitting data to each module. The master control circuit may particularly transmit to each module orders to turn on and/or turn off the switches of the module. Each module may transmit to the master control circuit data, particularly data originating from sensors, for example, the voltage across each cell of the module or the temperature of each cell of the module.

The master control circuit may receive a set point value, for example, a set point value for the voltage and/or the current and/or of connection of a given number of cells, and select the cells to be connected or to be disconnected for each module to obtain the desired voltage and/or current. The transmission of the orders from the master control circuit to the modules is generally considered as priority-holding, particularly over the other signals exchanged between the master control circuit and the modules.

For certain applications, it may be desirable to provide a single bidirectional communication bus between the master control circuit and the modules, particularly to decrease the battery pack manufacturing costs. It may however be difficult to ensure a proper exchange of the signals between the master control circuit and the modules with different priorities assigned to the exchanged signals, particularly when the frequency of the transmission of orders to turn off and turn on switches of the master control circuit to the modules is high.

### SUMMARY OF THE INVENTION

Thus, an object of an embodiment is to provide a data exchange method, particularly for a battery, which overcomes at least some of the disadvantages of the previously-described data exchange methods.

Another object of an embodiment is for the transmission of the orders from the master control circuit of the battery to the modules not to be disturbed by the transmission of data other than the orders between the modules and the master control circuit.

Another object of an embodiment is to prevent conflicts between modules for the transmission of signals to the master control circuit.

An embodiment provides a method of communication between a first electronic circuit and second electronic circuits via a bidirectional bus allowing the full duplex communication, each second electronic circuit having a single identifier corresponding thereto, the method comprising the transmission by the first electronic circuit of first frames over the bus to the second electronic circuits, each first frame comprising the same number of bits, the bits of each first frame being distributed in successive groups of bits, the positions of the groups being the same in each first frame, a first group of bits among the groups of bits corresponding to a first identifier among the identifiers, a second group of bits among the groups of bits corresponding to orders to be executed by the second electronic circuit corresponding to the first identifier, and a third group of bits among the groups of bits corresponding to a second identifier among the identifiers, only the second electronic circuit corresponding to the second identifier being authorized to transmit a second frame to the first electronic circuit over the bus.

According to an embodiment, the first electronic circuit modifies the third group of bits of the first frames to cyclically scan all the identifiers according to a given order.

According to an embodiment, the first electronic circuit transmits a succession of first frames with the third group of words corresponding to the same second identifier if it has not received a second frame transmitted by the second electronic circuit corresponding to the second identifier.

According to an embodiment, the first electronic circuit successively transmits a plurality of first frames with the third group of words corresponding to a given value which does not correspond to one of the identifiers if, after the transmission of said succession of first frames, it still has not received a second frame transmitted by the second electronic circuit corresponding to the second identifier.

According to an embodiment, the first electronic circuit and the second electronic circuits form part of a battery of electrical accumulators, the electrical accumulators being distributed in assemblies of electrical accumulators, each second electronic circuit corresponding to the first identifier controlling the connection or the disconnection of each electrical accumulator of one of the assemblies based on said orders.

According to an embodiment, the orders are orders to turn on or off switches coupling the electrical accumulators.

According to an embodiment, when the first identifier is identical to the second identifier, the second electronic circuit corresponding to the first identifier executes the orders before the sending of the second frame.

According to an embodiment, each second electronic circuit is coupled to at least one voltage and/or current sensor, and the second frame comprises data representative of at least one value measured by the sensor coupled to the second electronic circuit corresponding to the second identifier.

According to an embodiment, the transmission by the first electronic circuit of the first frames over the bus to the second electronic circuits is performed periodically.

An embodiment also provides an electronic system comprising a first electronic circuit and second electronic circuits coupled to the first electronic circuit by a bidirectional bus configured to allow the full duplex communication, each second electronic circuit having a single identifier corresponding thereto, the first electronic circuit being configured to transmit first frames over the bus to the second electronic circuits, each first frame comprising the same number of bits, the bits of each first frame being distributed in successive groups of bits, the positions of the groups being the same in each first frame, a first group of bits among the groups of bits corresponding to a first identifier among the identifiers, a second group of bits among the groups of bits corresponding to orders to be executed by the second electronic circuit corresponding to the first identifier, and a third group of bits among the groups of bits corresponding to a second identifier among the identifiers, only the second electronic circuit corresponding to the second identifier being authorized to transmit a second frame to the first electronic circuit over the bus.

According to an embodiment, the system corresponds to a battery of electrical accumulators, the electrical accumulators being distributed in assemblies of electrical accumulators, each second electronic circuit being configured to control the connection and the disconnection of each electrical accumulator of one of the assemblies based on said orders.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 partially and schematically shows an embodiment of a battery of accumulators;

FIG. 2 is a block diagram illustrating an embodiment of a method of communication in the battery of FIG. 1 seen on the master control circuit side;

FIG. 3 is a block diagram illustrating an embodiment of a method of communication in the battery of FIG. 1 seen on the side of one of the slave control circuits; and

FIG. 4 partially and schematically shows an example of a module of the battery of FIG. 1.

### DESCRIPTION OF THE EMBODIMENTS

Like features have been designated by like references in the various figures. In particular, the structural and/or functional features that are common among the various embodiments may have the same references and may dispose identical structural, dimensional and material properties. For the sake of clarity, only the steps and elements that are useful for an understanding of the embodiments described herein have been illustrated and described in detail. In particular, the conventional functions carried out by a master control circuit of a battery of accumulators such as cell balancing are well known by those skilled in the art and are not described in further detail hereafter. Further, a signal which alternates between a first constant state, for example, a low state, noted “0”, and a second constant state, for example, a high state, noted “1”, is called a “binary signal”. The high and low states of different binary signals of a same electronic circuit may be different. In practice, the binary signals may correspond to voltages or to currents which may not be perfectly constant in the high or low state.

In the following disclosure, unless otherwise specified, when reference is made to absolute positional qualifiers, such as the terms “front”, “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made to the orientation shown in the figures. Unless specified otherwise, the expressions “around”, “approximately”, “substantially” and “in the order of” signify within 10%, and preferably within 5%.

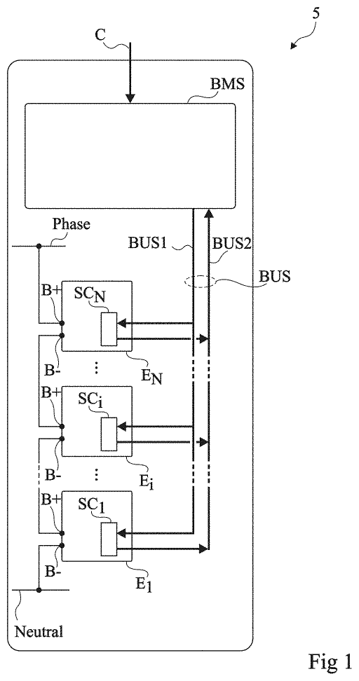

FIG. 1 shows an embodiment of a battery 5. Battery 5 comprises N modules E₁ to E_{N}. Number N is an integer that may be in the range from 1 to 50. Each module comprises a positive terminal B+ and a negative terminal B− and a plurality of cells, not shown, capable of being connected together, in series and/or in parallel, via switches, not shown, between terminals B+ and B−. Modules E₁ to E_{N} may be series-connected between a first terminal Neutral of battery 5 and a second terminal Phase of battery 5. An example of such a battery is described in patent application WO 2012/117110.

Battery 5 comprises a circuit BMS for controlling modules E₁ to E_{N}, called master control circuit hereafter. Master control circuit BMS may correspond to a dedicated circuit or may comprise a processor, for example, a microprocessor or a microcontroller, capable of executing instructions of a computer program stored in the memory. Master control circuit BMS may exchange data with each module E₁ to E_{N} via a data transmission bus BUS, also called communication bus. Data transmission bus BUS is a bidirectional bus. Each module Eᵢ, with i varying from 1 to N, comprises a circuit SCᵢ, called slave control circuit hereafter, configured to control the switches of module Eᵢ based on orders delivered by master control circuit BMS. Each module Eᵢ further comprises sensors, not shown, for example, sensors of the voltage across each cell of the module, sensors of the current supplied by each cell of the module, and/or sensors of the temperature of each cell of the module. The slave control circuit SCᵢ of each module E₁ to E_{N} is adapted to transmitting to master control circuit BMS data over data transmission bus BUS, for example, data representative of the voltage, current, temperature measurements, of the state of the cells, etc.

Master control circuit BMS is configured to receive a set point value C, for example, a set point value for the voltage and/or the current and/or the connection of a given number of electric cells between the Phase and Neutral terminals, and to select the cells to be connected or disconnected for each module to obtain the desired voltage and/or current between terminals Phase and Neutral of battery 5. Master control circuit BMS then delivers orders to the modules over the data transmission bus BUS, based on which the slave control circuit SCᵢ of each module Eᵢ connects or disconnects the cells of module Eᵢ according to the desired configuration.

Data transmission bus BUS is a bidirectional bus. According to an embodiment, battery 5 comprises no other bus of data transmission from master control circuit BMS to modules E₁ to E_{N}, and no other bus of data transmission from modules E₁ to E_{N} to master control circuit BMS. According to an embodiment, data transmission bus BUS is a fast bus, that is, a bus over which data are transmitted with a flow rate greater than 3 megabits per second, preferably in the range from 5 megabits per second to 7 megabits per second. As an example, data transmission bus BUS is a bus according to the RS485 standard.

According to an embodiment, data transmission bus BUS is a bidirectional bus which allows a full duplex communication, that is, the simultaneous transmission of signals in both directions. Data transmission bus BUS may comprise at least a first line BUS1 of data transmission from master control circuit BMS to each slave control circuit SCᵢ and a second line BUS2 of data transmission from each slave control circuit SCᵢ to master control circuit BMS.

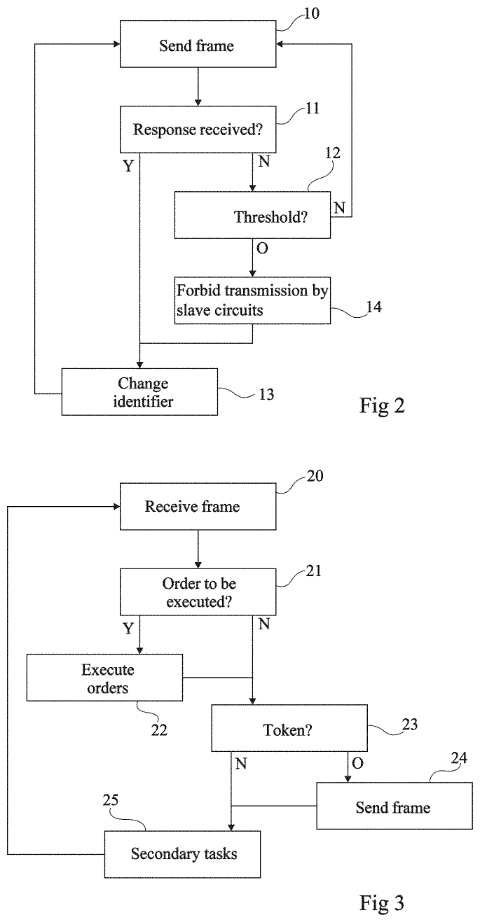

FIG. 2 is a block diagram illustrating an embodiment of a method of data transmission from master control circuit BMS to slave control circuits SC₁ to SC_{N}.

At a step 10 (Send frame), master control circuit BMS transmits a data frame over data transmission bus BUS. A data frame comprises a series of bits.

According to an embodiment, master control circuit BMS substantially periodically transmits frames over data transmission bus BUS. The frequency of transmission of the successive frames by master control circuit BMS over data transmission bus BUS may be in the range from 1 kHz to 50 kHz, for example, equal to approximately 20 kHz.

According to an embodiment, the frames transmitted by master control circuit BMS over data transmission bus BUS have the same size, that is, they each comprise the same number of bits. According to an embodiment, each frame transmitted by master control circuit BMS over data transmission bus BUS may have a number of bits in the range from 50 bits and 100 bits, for example, approximately 70 bits.

According to an embodiment, the frames transmitted by master control circuit BMS over data transmission bus BUS have the same structure. This means that the bits of the frame are distributed in groups of successive bits, each group of bits corresponding to specific data, and the position of each group of bits in the frame is the same from one frame to the other, that is, for each group, the position of the first bit in the group is the same for each frame and the position of the last bit in the group is the same for each frame.

The fact for the frames transmitted by master control circuit BMS over data transmission bus BUS to have the same size and the same structure advantageously enables to ease the processing of the frames by the slave control circuits.

According to an embodiment, each slave circuit has a different identifier associated therewith. A first group of bits among the groups of bits of the frame corresponds to an identifier of one of the modules E₁ to E_{N} to which orders to connect/disconnect the cells of the modules are sent with the same frame. A second group of bits among the groups of bits of the frame corresponds to orders to connect/disconnect the cells, that is, orders to turn off/turn on the switches of the module having as an identifier that of the first group. According to an embodiment, each frame transmitted by master control circuit BMS only comprises the orders of cell connection/disconnection, totally or partly, for a single one of modules E₁ to E_{N}. According to an embodiment, for a specific value of the first group of bits, the orders of the second group of bits may be processed by each slave control circuit as being intended for it. This advantageously enables to send the same orders simultaneously to all slave circuits.

According to an embodiment, master control circuit BMS performs a balancing of the cells, that is, the cell selection is performed so that the differences between the states of charge of the cells are permanently as small as possible. According to an embodiment, master control circuit BMS takes into account for the cell selection a possible failure of a cell so as to, for example, exclude this cell from the selection. According to an embodiment, master control circuit BMS selects cells to be connected/disconnected while ensuring that each cell operates in its optimal operating range according to the voltage, current, and temperature measurements supplied by the modules.

A third group of bits among the groups of bits corresponds to an identifier of one of modules E₁ to E_{N} which is authorized to transmit data over data transmission bus BUS. The module corresponding to the identifier of the third group of bits may be identical to or different from the module corresponding to the identifier of the first group of bits. The identifier of the third group of bits is called token hereafter to distinguish it from the identifier of the first group of bits.

A fourth group of bits among the groups of bits of the frame corresponds to data other than cell connection/disconnection orders, called slow data hereafter, and which are intended for all the slave control circuits. The slow data may comprise an operating mode of the modules of the battery pack, between for example, a normal operating mode, where the cells can be connected/disconnected, and a maintenance operating mode, where for example a program is transmitted to the slave control circuits. The slow data may comprise programming data, particularly a program executed by the slave control circuits.

Generally, the reading of the bits of the frame by each slave control circuit, from the first bit in the frame to the last bit in the frame, is not performed at once, but set of bits after set of bits, each set of bits comprising the same number of bits. A group of bits such as previously defined may correspond to a plurality of successive sets of bits. Each set of bits for example corresponds to a byte.

According to an embodiment, one of the bits of each set of bits at a fixed position in the set of bits, for example, the most significant bit in the set of bits or the least significant bit in the set of bits, is in a first state, for example, at “1”, for the first read set of bits in a frame, and is in a second state, for example, at “0”, for all the other sets of bits in the frame. This enables to ease the detection of the reception of a new frame by the slave control circuits.

According to an embodiment, one of the bits of each set of bits at a fixed position in the set of bits, for example, the most significant bit in the set of bits or the least significant bit in the set of bits, is in a first state, for example, at “1”, for the last read set of bits in a frame, and is in a second state, for example, at “0”, for all the other sets of bits in the frame. This enables to ease the detection of the end of the reception of the current frame by the slave control circuits.

At a step 11 (Response received?), master control circuit BMS determines whether it has received a response from the slave control circuit corresponding to the token of the frame transmitted at step 10. If, at step 11, master control circuit BMS has not received a response (N), the method carries on at a step 12 (Threshold?). If, at step 11, master control circuit BMS determines that it has received a response from the slave control circuit corresponding to the token of the last transmitted frame (Y), the method carries on at a step 13 (Change identifier).

At step 12, master control circuit BMS determines whether a sufficient number of frames comprising the same token has been transmitted. If such is not the case (N), the method carries on at step 10 at which master control circuit BMS transmits a new frame with the same token as the previous frame. However, for this new frame, the first, second, and fourth previously-described data groups may be different from those of the previous frame transmitted by master control circuit BMS. If, at step 12, master control circuit BMS determines that a sufficient number of frames comprising the same token has been transmitted (Y), the method carries on at a step 14 (Wait). Master control circuit BMS determines that a sufficient number of frames comprising the same token has been transmitted, for example, when the number of frames successively transmitted by master control circuit BMS with the same token exceeds a number or when frames are successively transmitted by the master control circuit with the same token for a determined duration, for example, 1 ms.

At step 14, master control circuit BMS transmits over communication bus BUS, for a determined duration, frames having a token corresponding to none of the identifiers of the slave control circuits (or the previous token), which indicates that no slave control circuit is authorized to transmit over communication bus BUS. This determined duration may be in the range from 100 μs to 5 ms, for example, equal to approximately 500 μs. This enables to take into account the case where the slave control circuit, corresponding to the token of the last frame transmitted at step 10 by master control circuit BMS, only starts responding to master control circuit BMS little after the transmission of this frame. The method carries on, after the determined duration, at step 13.

At step 13, master control circuit BMS modifies the token to be used in the next frame to be transmitted at step 10 to designate another slave control circuit. The method carries on at step 10 during which master control circuit BMS transmits a frame containing the new token over communication bus BUS.

According to an embodiment, each slave control circuit SCᵢ can only transmit a frame over communication bus BUS after the reception of a frame, transmitted by master control circuit BMS, comprising the token corresponding thereto. This enables to avoid for two slave control circuits to simultaneously transmit frames over communication bus BUS. Master control circuit BMS changes the token in the next frame to be transmitted only when it has received a satisfactory response from the slave control circuit having the currently-used token corresponding thereto or when a threshold is reached as previously described. When master control circuit BMS has not received a response from the slave control circuit corresponding to the last token used at the end of step 14, master control circuit BMS can then consider that the slave control circuit having the token corresponding thereto is defective.

According to an embodiment, master control circuit BMS uses, in the transmitted frames, the tokens corresponding to all the slave control circuits according to a given order, for example from the token corresponding to slave control circuit SC₁ to the token corresponding to slave control circuit SC_{N}. When all identifiers have been used, master control circuit BMS starts using the tokens from the beginning again according to the given order. Thereby, the slave control circuits are authorized to transmit data to master control circuit BMS in turns. Advantageously, this enables each slave control circuit to be regularly polled.

According to an embodiment, as soon as a slave control circuit receives a frame transmitted by master control circuit BMS comprising the token which is associated therewith, it tries to transmit as a response a frame over communication bus BUS as fast as possible. However, according to an embodiment, when the slave control circuit receives a frame transmitted by master control circuit BMS comprising both the token which is associated therewith and the identifier of the first group of bits which is associated therewith, the slave control circuit executes the orders indicated in the frame before trying to transmit as a response a frame over communication bus BUS.

FIG. 3 is a block diagram illustrating an embodiment of a method of data transmission from one of slave control circuits SCᵢ over communication BUS to master control circuit BMS. This method may be implemented by each slave control circuit.

At a step 20 (Receive frame), slave control circuit SCᵢ detects a frame over communication bus BUS transmitted by master control circuit BMS. The method carries on at a step 21 (Order to be executed?).

At step 21, the slave control circuit determines whether the first group of bits in the frame, corresponding to the identifier of one of the modules E₁ to E_{N} to which orders of connection/disconnection of the cells of the module are sent with the same frame, corresponds to its identifier. If the first group effectively corresponds to the identifier of control circuit SCᵢ (Y), the method carries on at a step 22 (Execute orders). If the first group does not correspond to the identifier of control circuit SCᵢ(N), the method caries on at a step 23 (Token?).

At step 22, the slave control circuit controls the connection and/or the disconnection of electrical accumulators of the module according to the orders present in the frame. The method carries on at step 23.

At step 23, the slave control circuit determines whether the token present in the received frame is that corresponding thereto. If the token effectively corresponds to that of the slave control circuit SCᵢ (Y), the method carries on at a step 24 (Send frame). If the token does not correspond to that of slave control circuit SCᵢ (N), the method carries on at a step 25 (Secondary tasks).

At step 24, slave control circuit SCᵢ elaborates a response frame, that it transmits over communication bus BUS. As an example, the response frame may contain the voltage values of the cells of the module, the temperature values of the cells of the module, the operation states of the cells of the module, other operating defects of the module and/or information relative to the programs executed by slave control circuit SCᵢ.

At step 25, the slave control circuit carries out secondary tasks other than those carried out at step 22 and step 24. It may be the collecting of measured voltage, current, temperature values, etc. and the processing of the collected data. Step 25 is interrupted as soon as a new frame transmitted by master control circuit BMS over communication bus BUS is received. The method then carries on at step 20. Step 24 may also be interrupted as soon as a new frame transmitted by master control circuit BMS over communication bus BUS is received, the method then carrying on at step 20.

The frequency of transmission of the frames from the slave control circuits to the master control circuit may be smaller than the frequency of transmission of the frames from the master control circuit to the slave control circuits. The maximum frequency of transmission of the frames from the slave control circuits to the master control circuit may be in the order of 100 Hz.

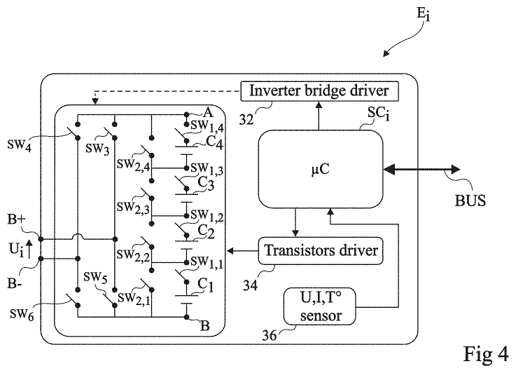

FIG. 4 shows an embodiment of module Eᵢ, where i varies from 1 to N.

According to the present embodiment, module Eᵢ is capable of delivering a voltage Uᵢ between positive terminal B+ and negative terminal B−. Module Eᵢ comprises cells C₁ to C_{M}, where M is an integer in the range from 2 to 10, preferably from 2 to 5, four cells C₁, C₂, C₃, and C₄ being shown as an example in FIG. 4. Cells C₁ to C_{M} are coupled together and to terminals B+ and B− by switches. In the present embodiment, for each cell Cₖ, k being an integer varying from 1 to M, module Eᵢ comprises a first switch SW_{1,k} in series with cell Cₖ and a second switch SW_{2,k} in parallel with the assembly comprising cell Cₖ and switch SW_{1,k}. The M assemblies comprising cell Cₖ and first switch SW_{1,k} are arranged in series between a node A and a node B. The control of switches SW_{1,k} and SW_{2,k}, with k varying from 1 to M, enables to place in series between nodes A and B from 1 to M cells among the M cells C₁ to C_{M}. In the present embodiment, module Eᵢ further comprises an inverter bridge, also called H bridge, between nodes A and B and terminals B+ and B−, which enables to apply the voltage present between nodes A and B between terminals B+ and B− in both directions. According to an embodiment, the inverter bridge comprises a switch SW₃ coupling node A to terminal B+, a switch SW₄ coupling node A to terminal B−, a switch SW₅ coupling node B to terminal B+, and a switch SW₆ coupling node B to terminal B−. As an example, each switch SW_{1,k} and SW_{2,k}, with k varying from 1 to M, SW₃, SW₄, SW₅, and SW₆ may correspond to an insulated-gate field-effect transistor, also called MOS (Metal Oxide Semiconductor) transistor, particularly a power MOS transistor, for example, an N-channel MOS transistor.

Each module Eᵢ further comprises slave control circuit SCᵢ (μC), adapted to exchanging data transmitted by master control circuit BMS over data transmission bus BUS. Slave control circuit SCᵢ may correspond to a dedicated circuit or may comprise a processor, for example, a microprocessor or a microcontroller, adapted to executing instructions of a computer program stored in a memory.

Each module Eᵢ further comprises a driver circuit 32 (Inverter bridge driver) coupled to switches SW₃, SW₄, SW₅ and SW₆ of the inverter bridge and a driver circuit 34 (Transistors driver) coupled to switches SW_{1,k} and SW_{2,k}, with k varying from 1 to M. Each driver circuit 32, 34 is capable of converting the control signals delivered by slave control circuit SCᵢ into signals adapted to the control of the switches.

Each module Eᵢ further comprises sensors 36 (U, I, T° sensor) coupled to slave control circuit SCᵢ. Module Eᵢ may further comprise, for each cell Cₖ, a temperature sensor adapted to measuring the temperature of cell Cₖ. Module Eᵢ may further comprise, for each cell Cₖ, a voltage sensor adapted to measuring the voltage across cell Cₖ. Module Eᵢ may further comprise a current sensor adapted to measuring the current flowing at node A or at node B. The slave control circuit SCᵢ of each module Eᵢ is adapted to transmitting third data to master control circuit BMS over data transmission bus BUS representative of the measurements performed by the sensors SCᵢ of module Eᵢ. The number and the type of sensors particularly depend on the arrangement of the cells of module Eᵢ. In the cell arrangement shown in FIG. 4, a single sensor of the current flowing at node A or at node B may be provided.

In the embodiment of a battery module Eᵢ illustrated in FIG. 4, an order to connect a cell Cₖ of a module Eᵢ means that cell Cₖ is to be series-connected between the nodes A and B of module Eᵢ, which is obtained by turning on switch SW_{1,k} and by turning off switch SW_{2,k}, and an order to disconnect a cell Cₖ of a module Eᵢ means that cell Cₖ should not be series-connected between the nodes A and B of module Eᵢ, which is obtained by turning off switch SW_{1,k} and by turning on SW_{2,k}. However, for a different arrangement of the cells Cₖ of module Eᵢ where cells Cₖ may be arranged in series or in parallel between nodes A and B, an order to connect cells Cₖ further specifies in which configuration, series or parallel, cell Cₖ is placed with respect to the other cells of module Eᵢ.

According to an embodiment, the second previously-defined group of each frame may, for the architecture of modules Eᵢ shown in FIG. 4, comprise:
an order to turn off/on switches SW_{1,1} and SW_{2,1};
an order to turn off/on switches SW_{1,2} and SW_{2,2};
an order to turn off/on switches SW_{1,3} and SW_{2,3};
an order to turn off/on switches SW_{1,4} and SW_{2,4}; and
the control of the H bridge.

Various embodiments and variants have been described. Those skilled in the art will understand that certain features of these various embodiments and variants may be combined, and other variants will occur to those skilled in the art. In particular, although, in the previously-described embodiments, master control circuit BMS substantially periodically transmits frames over data transmission bus BUS, master control circuit BMS irregularly, for example, randomly, transmits frames over data transmission bus BUS. Finally, the practical implementation of the embodiments and variants described herein is within the capabilities of those skilled in the art based on the functional indications provided hereinabove.

1. Method of communication between a first electronic circuit and second electronic circuits via a bidirectional bus allowing the full duplex communication, each second electronic circuit having a single identifier corresponding thereto, the method comprising the transmission by the first electronic circuit of first frames over the bus to the second electronic circuits, each first frame comprising the same number of bits, the bits of each first frame being distributed in successive groups of bits, the positions of the groups being the same in each first frame, the first frames being such that, in each first frame, a first group of bits among the groups of bits indicates a corresponding first identifier among the identifiers, a second group of bits among the groups of bits indicates corresponding orders to be executed by the second electronic circuit corresponding to the first identifier of the first frame, and a third group of bits among the groups of bits indicates a corresponding second identifier among the identifiers, the method being such that, as a response to the first frame of the plurality of first frames, only the second electronic circuit indicated by the corresponding second identifier is authorized to transmit a second frame to the first electronic circuit over the bus.

2. Method according to claim 1, wherein the first electronic circuit modifies the third group of bits of the first frames to cyclically scan all the identifiers according to a given order.

3. Method according to claim 1, wherein the first electronic circuit transmits a succession of first frames with the third group of words corresponding to the same second identifier if it has not received a second frame transmitted by the second electronic circuit corresponding to the second identifier.

4. Method according to claim 3, wherein the first electronic circuit successively transmits a plurality of first frames with the third group of words corresponding to a given value which does not correspond to one of the identifiers if, after the transmission of said succession of first frames, it still has not received a second frame transmitted by the second electronic circuit corresponding to the second identifier.

5. Method according to claim 1, wherein the first electronic circuit and the second electronic circuits form part of a battery of electrical accumulators, the electrical accumulators being distributed in assemblies of electrical accumulators, each second electronic circuit corresponding to the first identifier controlling the connection or the disconnection of each electrical accumulator of one of the assemblies based on said orders.

6. Method according to claim 5, wherein the orders are orders to turn on or off switches coupling the electrical accumulators.

7. Method according to claim 1, wherein, when the first identifier is identical to the second identifier, the second electronic circuit corresponding to the first identifier executes the orders before the sending of the second frame.

8. Method according to claim 1, wherein each second electronic circuit is coupled to at least one voltage and/or current sensor and wherein the second frame comprises data representative of at least one value measured by the sensor coupled to the second electronic circuit corresponding to the second identifier.

9. Method according to claim 1, wherein the transmission by the first electronic circuit of the first frames over the bus to the second electronic circuits is performed periodically.

10. Electronic system comprising a first electronic circuit and second electronic circuits coupled to the first electronic circuit by a bidirectional bus configured to allow the full duplex communication, each second electronic circuit having a single identifier corresponding thereto, the first electronic circuit being configured to transmit first frames over the bus to the second electronic circuits, each first frame comprising the same number of bits, the bits of each first frame being distributed in successive groups of bits, the positions of the groups being the same in each first frame, the first frames being such that, in each first frame, a first group of bits among the groups of bits indicates a corresponding first identifier among the identifiers, a second group of bits among the groups of bits to indicates corresponding orders to be executed by the second electronic circuit corresponding to the first identifier, and a third group of bits among the groups of bits indicates a corresponding second identifier among the identifiers, only the second electronic circuit indicated by the corresponding second identifier being authorized, as a response to each first frame of the plurality of first frames, to transmit a corresponding second frame to the first electronic circuit over the bus.

11. System according to claim 10, corresponding to a battery of electrical accumulators, the electrical accumulators being distributed in assemblies of electrical accumulators, each second electronic circuit being configured to control the connection and the disconnection of each electrical accumulator of one of the assemblies based on said orders.
